(19) United States
(12) Patent Application Publication
(10) Pub. No.: US 2006/0035601 A1
(43) Pub. Date: Feb. 16, 2006

(54) TDD transceiver for utilizing a transmission mode and a reception mode simultaneously, and a self-diagnostic method therefor

(75) Inventor: Cheol-Soo Seo, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/202,574

(22) Filed: Aug. 12, 2005

(30) Foreign Application Priority Data
Aug. 12, 2004 (KR) 2004-0063404

(51) Int. Cl. H04B 1/44

(52) U.S. Cl. 455/78

(57) ABSTRACT

A TDD transceiver for utilizing a Tx mode and an Rx mode simultaneously and a self-diagnostic method therefor. In the TDD transceiver, a transmitter transmits a Tx signal from a Tx path to an antenna. A receiver for processes an Rx signal to a baseband signal. A detector couples the Tx signal in the transmitter and provides the coupled Tx signal to the receiver. A diagnostic portion determines if the TDD transceiver is normal or abnormal using the Tx signal received from the receiver.

### PRIORITY

This application claims priority under 35 U.S.C. § 119 to an application entitled “TDD Transceiver For Utilizing Transmission Mode And Reception Mode Simultaneously And Self-Diagnostic Method Therefor” filed in the Korean Intellectual Property Office on Aug. 12, 2004 and assigned Serial No. 2004-63404, the contents of which are herein incorporated by reference.

### BACKGROUND OF THE INVENTION

1. Field of the Invention

The present invention relates generally to a Time Division Duplex (TDD) transceiver in a wireless communication system, and in particular, to a TDD transceiver for self-diagnosing characteristics of a transmission (Tx) signal and characteristics of a reception (Rx) path in a Tx mode operation by extracting the Tx signal from the Rx path, and a self-diagnostic method therefor.

2. Description of the Related Art

FIG. 1A is a block diagram illustrating a conventional TDD transceiver in a wireless communication system. Referring to FIG. 1A, a conventional TDD transceiver in a wireless communication system or in a mobile communication system includes a baseband processor 10, an intermediate frequency (IF) processor 20, and a radio frequency (RF) processor 30. The baseband processor 10 upconverts a Tx baseband signal to an IF signal or downconverts an Rx IF signal to a baseband signal through modulation/demodulation and filtering. Additionally, the baseband processor 10 includes a modulator & demodulator (MODEM) 11, a digital upconverter (DUC) 12, a digital downconverter (DDC) 14, and a field programmable gate array (FPGA) 13 for performing a user-set control function.

The IF processor 20 includes a digital-to-analog converter (DAC) 21 for converting a digital signal to an analog signal and an analog-to-digital converter (ADC) 27 for converting an analog signal to a digital signal. An analog IF signal from the DAC 21 is buffered in a buffer 22 and then modulated to an RF signal in a frequency synthesizer 23. A local oscillator 24 generates a signal by which the frequency synthesizer 23 upconverts the IF signal to the RF signal or a frequency synthesizer 25 downconverts an Rx RF signal to an IF signal, for demodulation.

The RF processor 30 radiates or receives an RF signal over the air. The RF processor a high power amplifier (HPA) 31 for transmission and a low noise amplifier (LNA) 33 for reception.

In the conventional TDD transceiver, an RF front-end unit detects data using a circulator or a switch in a Tx or Rx mode. In FIG. 1A, data detection is performed using an RF switch 32 in the Tx or Rx mode.

For transmission, the RF switch 32 switches a Tx signal from the HPA 31 to a band pass filter (BPF) 34 and for reception, the RF switch 32 switches an Rx signal from the BPF 34 to the LNA 33. The BPF 34 functions to band-pass-filter the Tx signal and the Rx signal.

A directional coupler (D/C) 35 is connected between the BPF 34 and an antenna for coupling the Tx signal and the Rx signal. The coupled signals are used to monitor abnormalities in the Tx signal and the Rx signal. More specifically, an external diagnostic block 40 diagnoses if the Tx signal and the Rx are normal or not using the coupled signals.

The TDD transceiver illustrated in FIG. 1A is configured such that the RF switch 32 switches between a Tx path and an Rx path. This configuration enables easy application. Another advantage of the configuration of FIG. 1 is that the TDD transceiver provides a high switch isolation even when an RF signal is asynchronous to a switch control signal, such that only RF power equal to or less than an acceptable level is introduced to the LNA 33 at a receiver. Despite these advantages, the high-power RF switch is very expensive and thus its use is limited to systems that transmit below 1 W.

FIG. 1B is a block diagram of another conventional TDD transceiver in a wireless communication system. Referring to FIG. 1B, an RF front-end unit is configured to detect data using an RF switch 37 and a circulator 36 in a Tx mode or in an Rx mode.

More specifically, the circulator 36 is an RF device with directionality that is characterized by signal transfer only in a specific direction (clockwise or counterclockwise) and signal isolation from the opposite direction. The circulator 36, which blocks introduction of a Tx signal into the receiver, offers typically an isolation of about 20 dB.

As described above, the RF front-end unit of the TDD transceiver uses the RF switch 32 or the circulator 36. Two considerations must be taken into account in designing the RF front-end unit: the receiver must be protected (1) against damage caused by the introduction of a Tx signal into the receiver in a Tx mode; and (2) the reception performance of the receiver must be prevented from degrading due to the introduction of a Tx signal into the receiver in an Rx mode (i.e. Tx off). These conditions are commonly applied to all TDD transceivers.

Traditionally, the wireless communication system uses the separately procured diagnostic block 40 to diagnose about the TDD transceiver. The external diagnostic block 40 analyzes the Tx signal and the Rx signal extracted by the D/C 35 at the front end of the RF processor 30. Typically, this external diagnostic block 40 detects the power and quality of the Tx signal, generates/detects a Tx/Rx test signal, detects the power and quality of the Rx signal, and performs other user-requested diagnostic functions.

Many of the diagnostic functions of the diagnostic block are set by user request, requiring additional hardware and cost. Despite the cost constraint, the diagnostic block is utilized because of service reliability. If a problem occurs in the system, no matter how instant it is, it leads to a big problem because it causes inconvenience to subscribers. Also, monitoring should continue in order to take immediate actions if problems are generated. Accordingly, a diagnostic device and a diagnostic function are significant to a base station.

However, the conventional TDD transceiver establishes a separate diagnosing path for diagnosis and test, and uses an external diagnosing circuit, thereby resulting in circuit complexity and increased cost.

### SUMMARY OF THE INVENTION

Therefore, the present invention has been designed to substantially solve at least the above problems and/or disadvantages and to provide at least the advantages below. Accordingly, an object of the present invention is to provide a TDD transceiver for self-diagnosing using an existing Rx path and circuit in order to monitor the performance characteristics of the TDD transceiver in real time, and a self-diagnostic method therefor.

The above and other objects are achieved by providing a TDD transceiver for utilizing a Tx mode and an Rx mode simultaneously and a self-diagnostic method therefor.

According to one aspect of the present invention, in a TDD transceiver in a wireless communication system, a transmitter transmits a Tx signal from a Tx path to an antenna. A receiver processes an Rx signal to a baseband signal. A detector couples the Tx signal in the transmitter and provides the coupled Tx signal to the receiver. A diagnostic portion determines if the TDD transceiver is normal or abnormal using the Tx signal received from the receiver.

According to another aspect of the present invention, in a TDD transceiver in a wireless communication system, an output portion transmits a Tx RF signal to an antenna. A receiver processes an RX signal to a baseband signal. A detector detects the Tx signal in the output portion and provides the detected Tx signal to the receiver. A diagnostic portion determines whether the TDD transceiver is normal or abnormal using the Tx signal received from the receiver.

According to a further aspect of the present invention, in a TDD transceiver in a wireless communication system, an output portion transmits a Tx RF signal to an antenna. A receiver processes an Rx signal to a baseband signal. A detector receives a leakage signal from the output portion and provides the leakage signal to the receiver. A diagnostic portion determines whether the TDD transceiver is normal or abnormal using the leakage signal received from the receiver.

According to still another aspect of the present invention, in a TDD transceiver in a wireless communication system, a transmitter transmits a Tx signal from a Tx path to an antenna. A receiver processes an Rx signal to a baseband signal. A first detector detects an IF signal from the transmitter and provides the detected IF signal to the receiver. A second detector detects an RF signal from the transmitter and provides the detected RF signal to the receiver. A diagnostic portion determines whether the TDD transceiver is normal or abnormal using the IF or RF signal received from the receiver.

According to yet another aspect of the present invention, in a TDD transceiving method in a wireless communication system, a Tx signal from a Tx path is provided to an antenna. The Tx signal is coupled in the Tx path and provided to an Rx path. The TDD transceiver is diagnosed using the Tx signal received from the Rx path to determine whether transmission and reception are normal or abnormal.

According to yet further aspect of the present invention, in a self-diagnostic method for a TDD transceiver in a wireless communication system, a normal diagnostic mode and a diagnostic path are set. One of a plurality of diagnostic threshold LUTs is selected. A diagnostic signal detected from a user-set point is selected. Thereafter, it is determined whether the TDD transceiver operates normally by comparing the diagnostic signal with the diagnostic threshold LUT.

According to still further aspect of the present invention, in a self-diagnostic method for a TDD transceiver in a wireless communication system, a test diagnostic mode and a diagnostic path are set. A reference signal is generated and one of diagnostic threshold LUTs is selected. A reference signal detected from a user-set point is selected as a diagnostic signal. Thereafter, it is determined whether the TDD transceiver operates normally by comparing the diagnostic signal with the diagnostic threshold LUT.

### BRIEF DESCRIPTION OF THE DRAWINGS

The above and other objects, features, and advantages of the present invention will become more apparent from the following detailed description when taken in conjunction with the accompanying drawings in which:

FIG. 1A is a block diagram illustrating a conventional TDD transceiver in a wireless communication system;

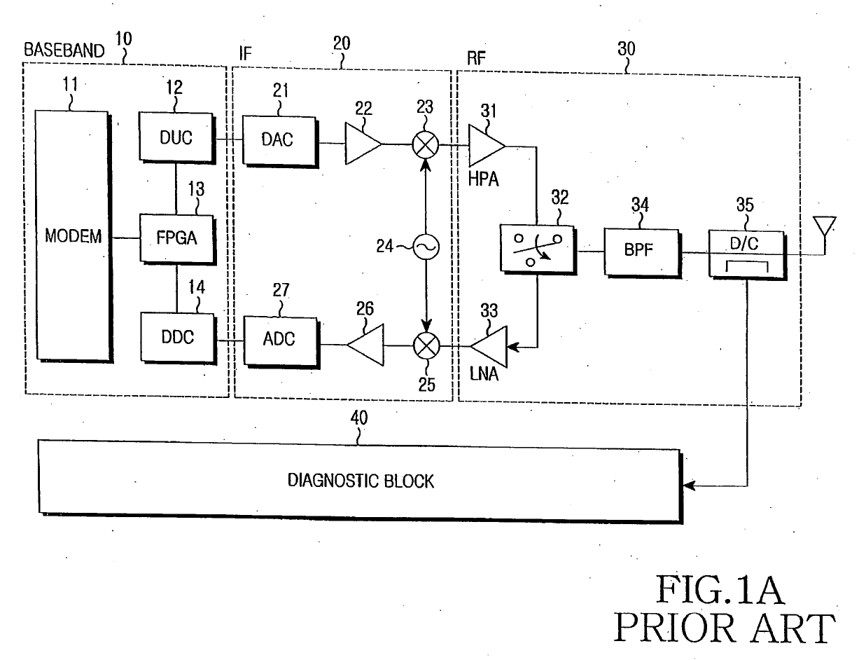

FIG. 1B is a block diagram illustrating another conventional TDD transceiver in a wireless communication system;

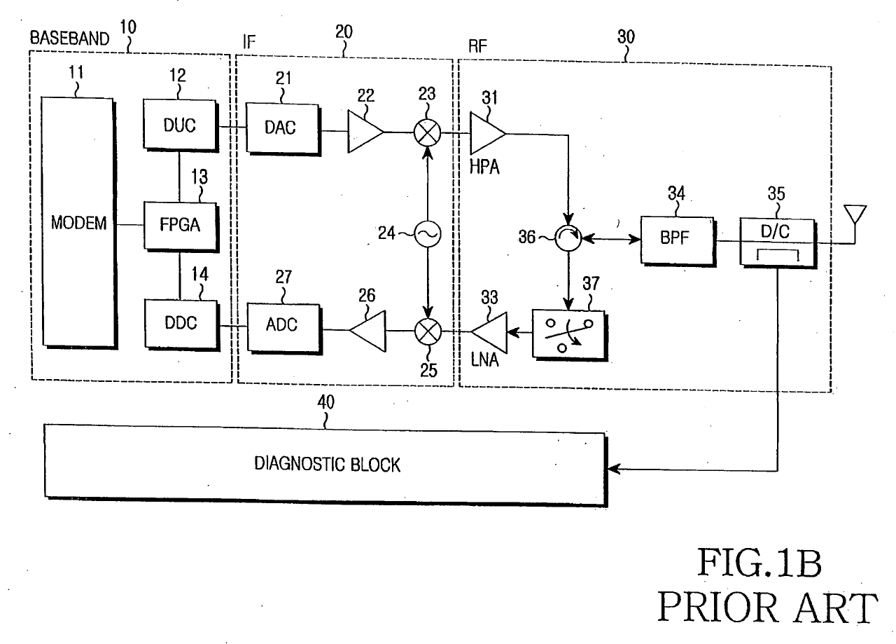

FIG. 2 illustrates a TDD transceiver in a wireless communication system and the operation principle of the TDD transceiver on a time axis according to the present invention;

FIG. 3A is a block diagram illustrating a TDD transceiver for extracting a Tx signal according to an embodiment of the present invention;

FIG. 3B is a block diagram illustrating a TDD transceiver for extracting a Tx signal according to another embodiment of the present invention;

FIG. 3C is a block diagram illustrating a TDD transceiver for extracting a Tx signal according to another embodiment of the present invention;

FIG. 3D is a block diagram illustrating a TDD transceiver for extracting a Tx signal according to another of the present invention;

FIG. 3E is a block diagram illustrating a TDD transceiver for extracting a Tx signal according to an embodiment of the present invention;

FIG. 3F is a block diagram illustrating a TDD transceiver for extracting a Tx signal according to an embodiment of the present invention;

FIG. 4 illustrates diagnostic paths in the TDD transceiver according to the present invention;

FIG. 5 illustrates diagnostic signal detection points in the TDD transceiver according to the present invention;

FIG. 6 illustrates a diagnostic block for detecting a diagnostic signal and diagnosing the TDD transceiver according to the present invention;

FIG. 7 is a block diagram of the diagnostic block in the TDD transceiver according to the present invention; and

FIG. 8 is a flowchart illustrating a diagnosing procedure in the TDD transceiver according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is directed to a technique for self-diagnosing a TDD transceiver using an existing Rx path and circuit, and thereby monitoring the performance characteristics of the TDD transceiver in real time.

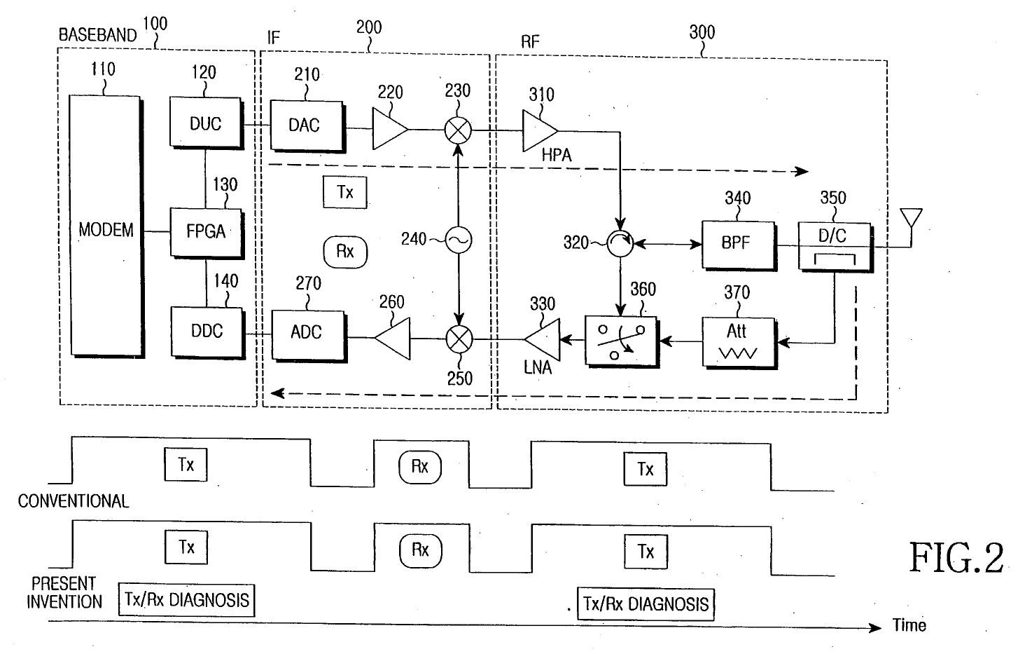

FIG. 2 illustrates a TDD transceiver in a wireless communication system according to the present invention. Like a conventional transceiver, the TDD transceiver includes a baseband processor 100, an IF processor 200, and an RF processor 300.

Referring to FIG. 2, the baseband processor 100 upconverts a Tx baseband signal to an IF signal or downconverts an Rx IF signal to a baseband signal through modulation/demodulation and filtering. The baseband processor 100 includes a MODEM 110 for modulation and demodulation, a DUC 120 for frequency upconversion, a DDC 140 for frequency downconversion, and an FPGA 130 for performing a user-set control function.

The IF processor 200 includes a DAC 210 for converting a digital signal to an analog signal and an ADC 270 for converting an analog signal to a digital signal. A Tx part of the IF processor 200 converts an analog IF signal from the DAC 210 to an RF signal. That is, the Tx part upconverts the IF signal to the RF signal and an Rx part downconverts an Rx RF signal to an IF signal in the IF processor 200. The IF signal is provided to the baseband processor 100 through a buffer 260 and the ADC 270.

The analog IF signal from the DAC 210 is buffered in a buffer 220 and then modulated to an RF signal in a frequency synthesizer 230. A local oscillator 240 generates a signal by which the frequency synthesizer 230 upconverts the IF signal to the RF signal or a frequency synthesizer 250 downconverts an Rx RF signal to an IF signal, for demodulation.

As described above, the RF processor 300 includes an RF switch 360 or a circulator 320 in compliance with the receiver protection criterion that the RF processor 300 shall not damage the receiver by allowing a Tx signal to be introduced into the receiver in a Tx mode. Therefore, all designers pay special attention blocking the Tx signal from being introduced into the receiver.

The present invention is characterized in that the receiver protection function being a common condition to be satisfied for TDD communications is performed, and a signal at a predetermined power level, i.e., at a power level that enables the receiver to operate normally, e.g., −65 dBm, is provided to the receiver and used to diagnose and test the function and performance of a Tx signal through an Rx circuit. Therefore, compared to the conventional technology, the Rx circuit is used even in a Tx mode in the TDD transceiver.

As illustrated in FIG. 2, in addition to the sequential Tx and Rx operations as performed in conventional TDD transceiver communications, the present invention further performs a detection and diagnosis operation on Tx and Rx signals using the receiver for diagnosing the transmitter in a Tx mode. Accordingly, the utilization of the TDD communication system on a time axis is increased. In order to perform this operation, the circulator 320 (or a switch), the RF switch 360, and a D/C 350 are used.

As described above, the circulator 320 is an RF device with directionality that is characterized by signal transfer only in a specific direction and signal isolation from the opposite direction.

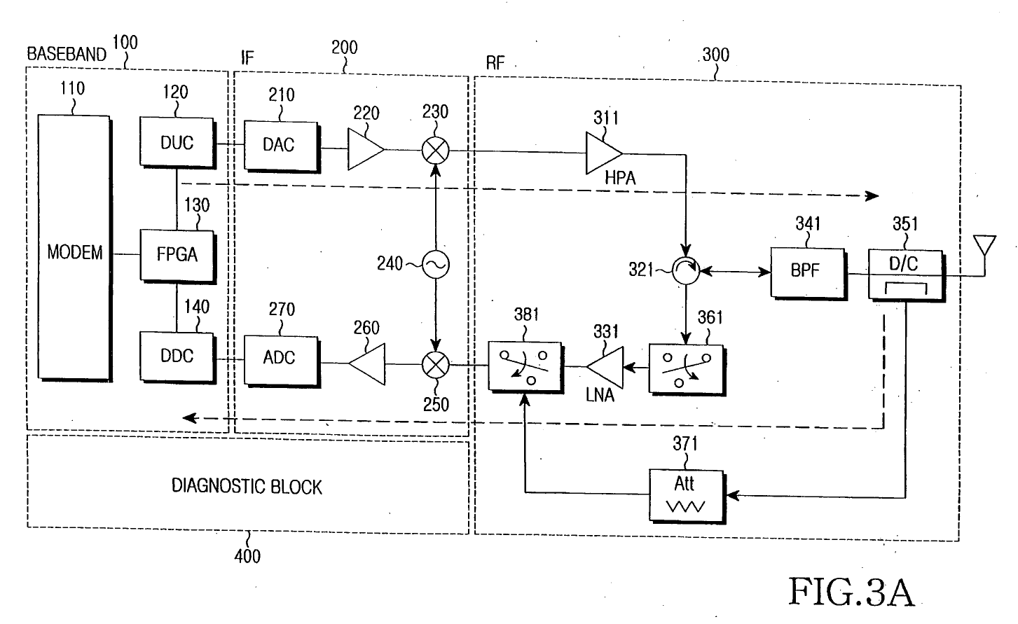

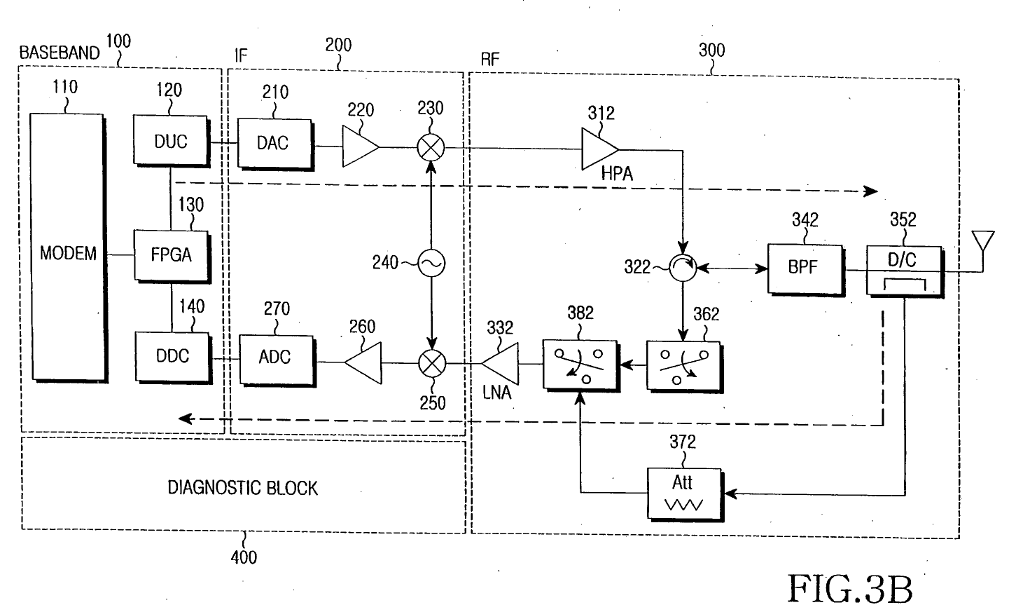

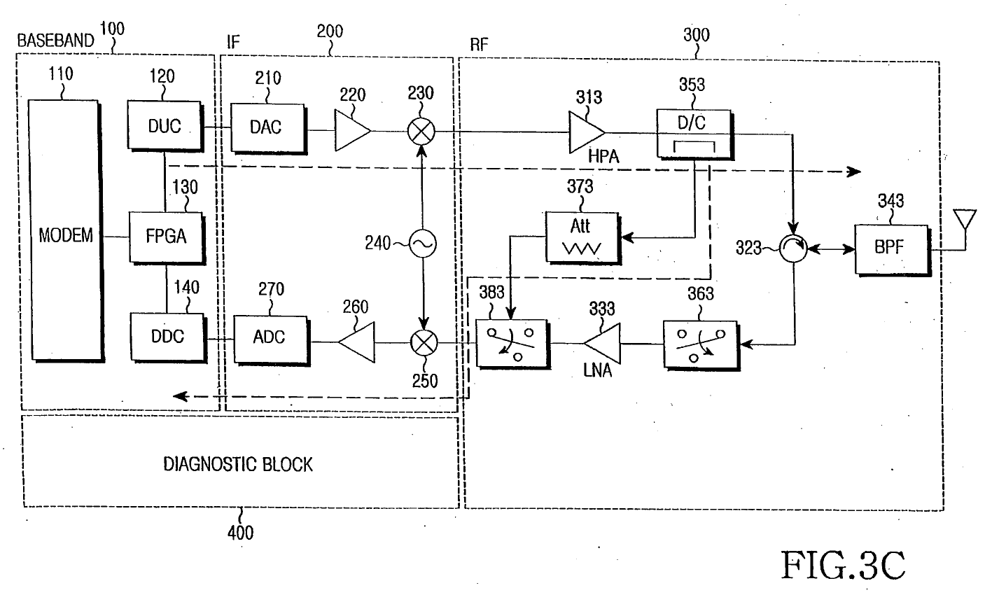

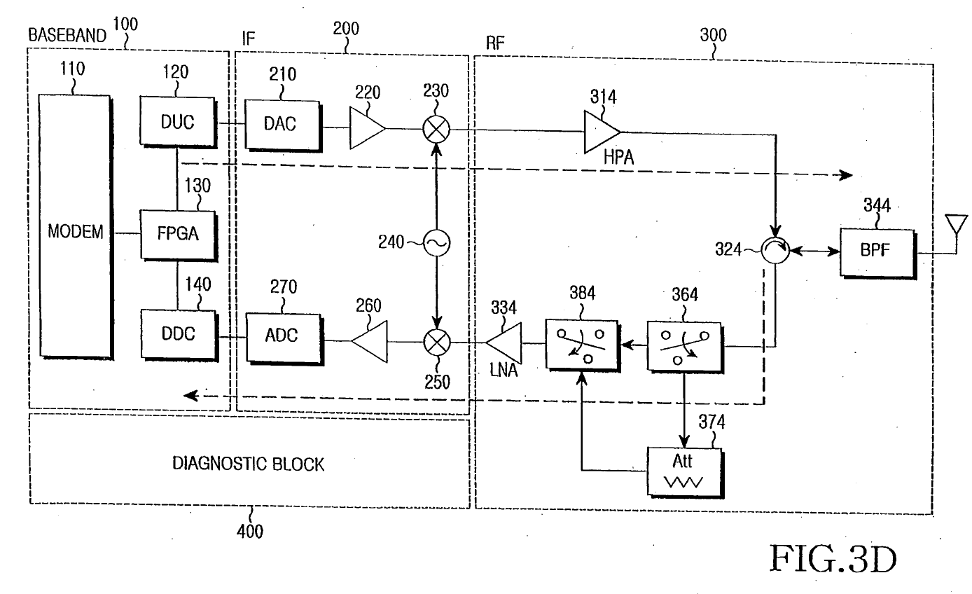

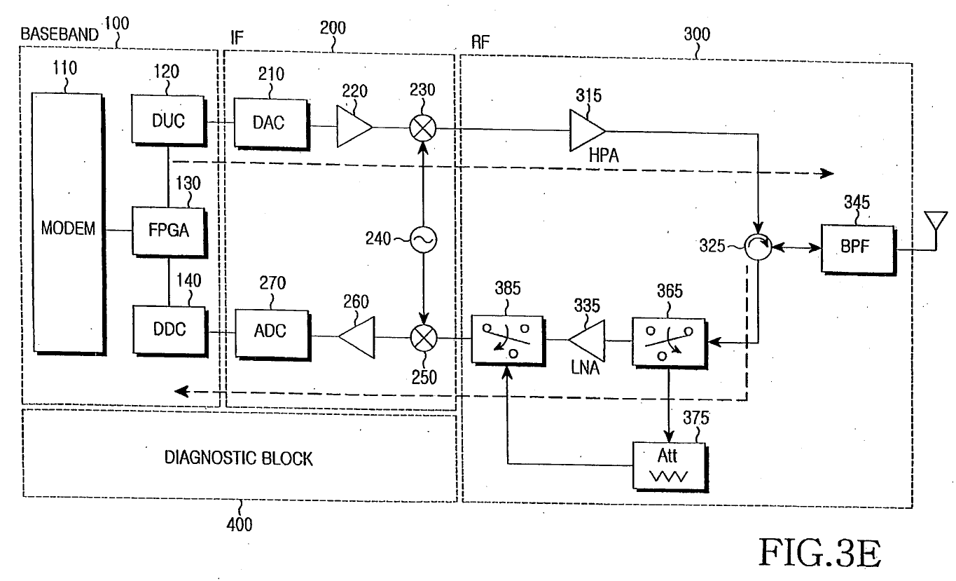

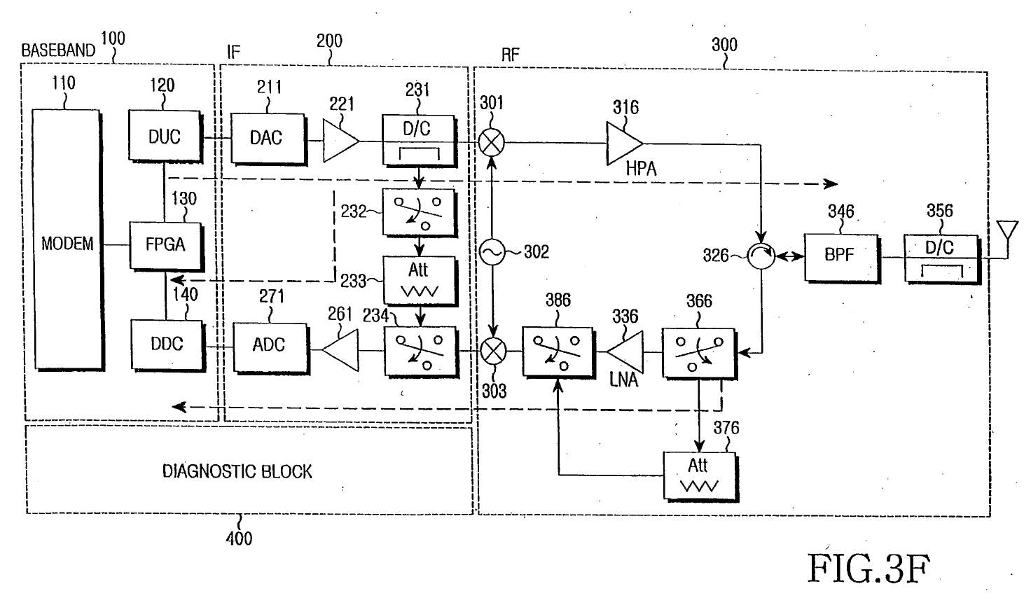

In FIG. 2, the circulator 320 transmits a signal from an HPA 310 to the D/C 350 and the RF switch 360 blocks a leakage signal from flowing through an LNA 330. The D/C 350 is connected between a BPF 340 and an antenna and couples the Tx signal and the Rx signal. The power level of the Tx signal introduced into the receiver can be adjusted appropriately by controlling a coupling value or using an attenuator 370. The coupling position of the Tx signal and the detection and diagnosing configuration of the TDD transceiver may vary, which will be described later in more detail with references to FIGS. 3A to 3F.

In the TDD transceiver of the present invention, the FPGA 130 detects the power and quality of the Tx signal using the Rx circuit, and determines whether the Tx signal is normal or not using a predetermined threshold set in a look-up table (LUT). Therefore, system performance is improved and cost is reduced with simple circuits, without an additional hardware configuration.

This TDD transceiver configuration eliminates the need for a separate diagnosing circuit for diagnosing the transmitter and enables simultaneous testing of the transmitter and the receiver. Also, hardware is more efficiently utilized on the time axis. For example, in a system requiring precision control and real-time diagnosis of the Tx signal, the present invention improves system performance.

In the following description of FIGS. 3A-3F, because each transceiver includes many of the same components, a description of the same components will not be repeated.

FIG. 3A is a block diagram illustrating a TDD transceiver for extracting a Tx signal according to an embodiment of the present invention. Referring to FIG. 3A, the RF processor 300 transmits a signal upconverted by the baseband processor 100 and the IF processor 200 through a circulator 321.

As described above, the circulator 321 transmits an input signal only in a predetermined direction, while isolating the signal from the opposite direction. Yet, although a signal from an HPA 311 is mostly provided to a BPF 341 by the circulator 321, a Tx leakage signal is more or less introduced to an LNA 331 though the circulator 321.

Accordingly, a first switch 361 is switched to block the Tx leakage signal from being transmitted to the LNA 331. The BPF 341 transmits the signal in the Tx path from the RF processor 300 to a D/C 351. That is, the BPF 341 band-pass-filters the Tx signal and the Rx signal. The D/C 351, which is connected between the BPF 341 and an antenna, couples the Tx signal and the Rx signal.

The D/C 351 at the Tx part transmits the coupled Tx signal to the Rx circuit of the RF processor 300. Because the power level of the detected Tx signal is relatively very higher than that of a normal Rx signal, it is introduced into the Rx path through an attenuator 371 that provides a predetermined degree of attenuation, e.g., 60 dB to 90 dB attenuation.

Depending on whether the detected Tx signal is to be diagnosed, a second switch 381 is connected to or disconnected from the attenuator 371. If the second switch 381 switches to the attenuator 371, a diagnostic block 400 determines whether the transmitter and receiver are normal or abnormal by diagnosing the detected Tx signal output from the D/C 351.

When the second switch 381 is connected to the attenuator 371, the first switch 361 blocks the Tx leakage signal from being transmitted to the LNA 331.

FIG. 3B is a block diagram of a TDD transceiver for extracting a Tx signal according to another embodiment of the present invention. Referring to FIG. 3B, this TDD transceiver detects a Tx signal using a D/C 352, similar to the TDD transceiver illustrated in FIG. 3A.

Referring to FIG. 3B, the RF processor 300 transmits a signal upconverted by the baseband processor 100 and the IF processor 200 through a circulator 322. The D/C 352 detects the Tx signal and provides it to the Rx circuit of the RF processor 300. The detected Tx signal is introduced into an Rx path through an attenuator 372.

A first switch 362 is switched to block a Tx leakage signal from being transmitted to an LNA 332. Depending on whether the detected Tx signal is to be diagnosed, a second switch 382 is connected to or disconnected from the attenuator 372. If the second switch 382 switches to the attenuator 372, the diagnostic block 400 determines whether the transmitter and receiver are normal or abnormal by diagnosing the detected Tx signal output from the D/C 352.

When the second switch 382 is connected to the attenuator 372, the first switch 362 blocks the Tx leakage signal from being transmitted to the LNA 332.

FIG. 3C is a block diagram of a TDD transceiver for extracting a Tx signal according to another embodiment of the present invention. Referring to FIG. 3C, this TDD transceiver detects a Tx signal using a D/C 353, similar to the TDD transceiver illustrated in FIG. 3A. The RF processor 300 detects a Tx signal through a D/C 353 prior to transmission of the Tx signal upconverted by the baseband processor 100 and the IF processor 200 through a circulator 323. The detected Tx signal is introduced into the Rx circuit of the RF processor 300 through an attenuator 373. Depending on whether the detected Tx signal is to be diagnosed, a second switch 383 is connected to or disconnected from the attenuator 373.

If the second switch 383 switches to the attenuator 373, the diagnostic block 400 determines whether the transmitter and receiver are normal or abnormal by diagnosing the detected Tx signal output from the D/C 353. It is to be noted here that a first switch 363 is switched to block a Tx leakage signal from being transmitted to an LNA 333.

FIG. 3D is a block diagram of a TDD transceiver for extracting a Tx signal according to another embodiment of the present invention. Referring to FIG. 3D, this TDD transceiver detects Tx leakage power from a circulator 324, different than the TDD transceiver illustrated in FIG. 3A.

Referring to FIG. 3D, the RF processor 300 transmits a Tx signal upconverted by the baseband processor 100 and the IF processor 200 through a circulator 324. Tx leakage power from the circulator 324 is used for diagnosis. A first switch 364 switches the detected Tx signal, i.e., the Tx leakage power, to an attenuator 374. The detected Tx signal is introduced into the Rx circuit of the RF processor 300 through the attenuator 374. Depending on whether the detected Tx signal is to be diagnosed, a second switch 384 is connected to or disconnected from the attenuator 374.

If the second switch 384 switches to the attenuator 374, the diagnostic block 400 determines whether the transmitter and receiver are normal or abnormal by diagnosing the detected Tx leakage power from the circulator 324.

When the second switch 384 switches to the attenuator 374, the first switch 364 also switches to the attenuator 374. When the Tx leakage power is introduced into the receiver without passing through the attenuator 374, it may destroy the receiver. Therefore, the second switch 384 switches to the attenuator 374 in order to block the introduced Tx leakage power.

FIG. 3E is a block diagram of a TDD transceiver for extracting a Tx signal according to another embodiment of the present invention. Referring to FIG. 3E, this TDD transceiver detects Tx leakage power from a circulator 325, similar to the TDD transceiver illustrated in FIG. 3D.

Referring to FIG. 3E, the RF processor 300 transmits a Tx signal upconverted by the baseband processor 100 and the IF processor 200 through a circulator 325. Tx leakage power from the circulator 325 is used for a diagnosis.

A first switch 365 switches the detected Tx signal, i.e., the Tx leakage power, to an attenuator 375. The detected Tx signal is introduced into the Rx circuit of the RF processor 300 through the attenuator 375. Depending on whether the detected Tx signal is to be diagnosed, a second switch 385 is connected to or disconnected from the attenuator 375.

If the second switch 385 switches to the attenuator 375, the diagnostic block 400 determines whether the transmitter and receiver are normal or abnormal by diagnosing the detected Tx leakage power from the circulator 325. Simultaneously, the first switch 365 blocks the Tx leakage power from being introduced into an LNA 335, thereby excluding the LNA 335 from the diagnosis operation.

FIG. 3F is a block diagram of a TDD transceiver for extracting a Tx signal according to another embodiment of the present invention. Referring to FIG. 3F, this TDD transceiver is characterized in that a Tx signal is detected using both a D/C 231 and a circulator 326. That is, the D/C 231 extracts an IF signal and the circulator 326 extracts an RF signal.

Referring to FIG. 3F, the IF processor 200 detects the Tx signal received from the baseband processor 100 through the D/C 231, for Tx signal diagnosis. Depending on Tx signal detection, a first switch 232 is connected to or disconnected from an attenuator 233.

The IF Tx signal detected by the D/C 231 is introduced to the Rx circuit of the IF processor 200 through the attenuator 233. Depending on whether the detected Tx signal is to be diagnosed, a second switch 234 is connected to or disconnected from the attenuator 233.

If the second switch 234 switches to the attenuator 233, the diagnostic block 400 determines whether the transmitter and receiver are normal or abnormal by diagnosing the detected Tx IF signal from the D/C 231.

The RF processor 300 transmits the Tx signal received from the IF processor 200 through the circulator 326. Tx leakage power is detected from the circulator 326.

A third switch 366 provides the detected Tx signal, i.e., the Tx leakage power, to an attenuator 376. The detected Tx signal is introduced into the Rx circuit of the RF processor 300 through the attenuator 376. Depending on whether the detected Tx signal is to be diagnosed, a fourth switch 386 is connected to or disconnected from the attenuator 376.

For diagnosing the detected Tx signal, the third and fourth switches 366 and 386 must simultaneously switch to the attenuator 376. If the third switch 366 switches to an LNA 336, the fourth switch 386 switches to the attenuator 376 to protect the receiver against the introduction of an excess Rx signal. That is, if the fourth switch 386 switches to the attenuator 376, the diagnostic block 400 determines whether the transmitter and receiver are normal or abnormal by diagnosing the detected Tx leakage power from the circulator 326. The second switch 234 of the IF processor 200 is connected to the Rx circuit of the RF processor 300, thereby blocking the detected TX signal from the D/C 231 into being introduced into the receiver.

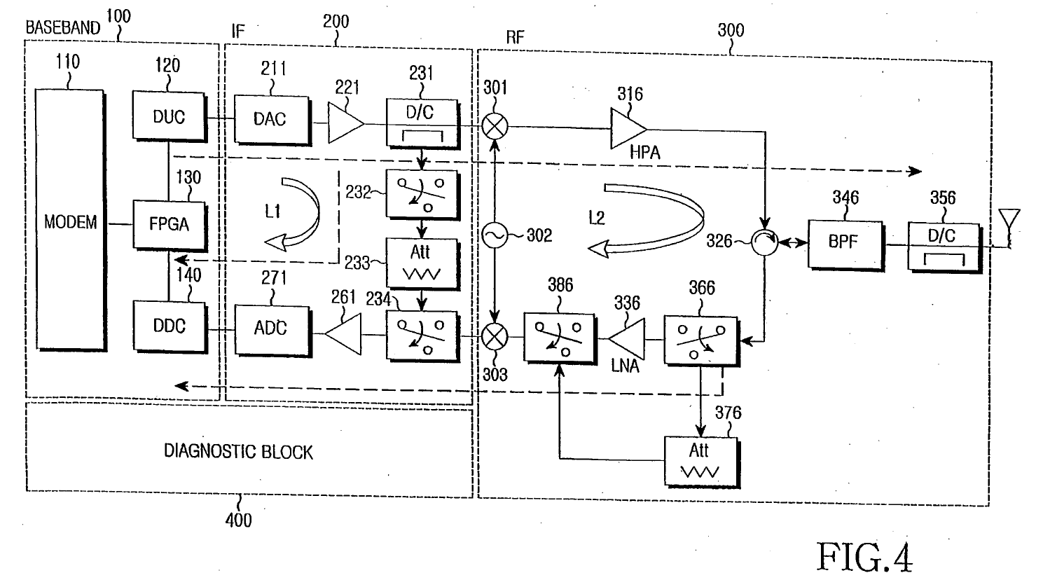

FIG. 4 illustrates diagnostic paths in the TDD transceiver according to the present invention. Depending on system control, a diagnostic path may start from the RF processor 300 or the IF processor 200. Because arbitrary Tx and Rx paths can be involved in setting a diagnostic path, a diagnosis can be made in various paths.

The diagnostic paths illustrated in FIG. 4 are described in the context of the TDD transceiver as illustrated in FIG. 3F.

Referring to FIG. 4, a first diagnostic path L1 is defined by Tx signal detection from the D/C 231 and diagnosis of the detected Tx signal, whereas a second diagnostic path L2 is defined by Tx signal detection from the circulator 326 and diagnosis of the detected Tx signal. Along the first diagnostic path L1, the D/C 231 in the IF processor 200 detects the TX signal received from the baseband processor 100 and the detected Tx signal is introduced into the Rx circuit of the IF processor 200, for Tx signal diagnosis. Along the second diagnostic path L2, the circulator 326 in the RF processor 300 transmits the TX signal received from the IF processor 200 and the Tx signal is detected using Tx leakage power generated during the transmission operation. The second switch 234 of the IF processor 200 is connected to the Rx circuit of the RF processor 300. Therefore, the second switch 234 selects one of L1 and L2.

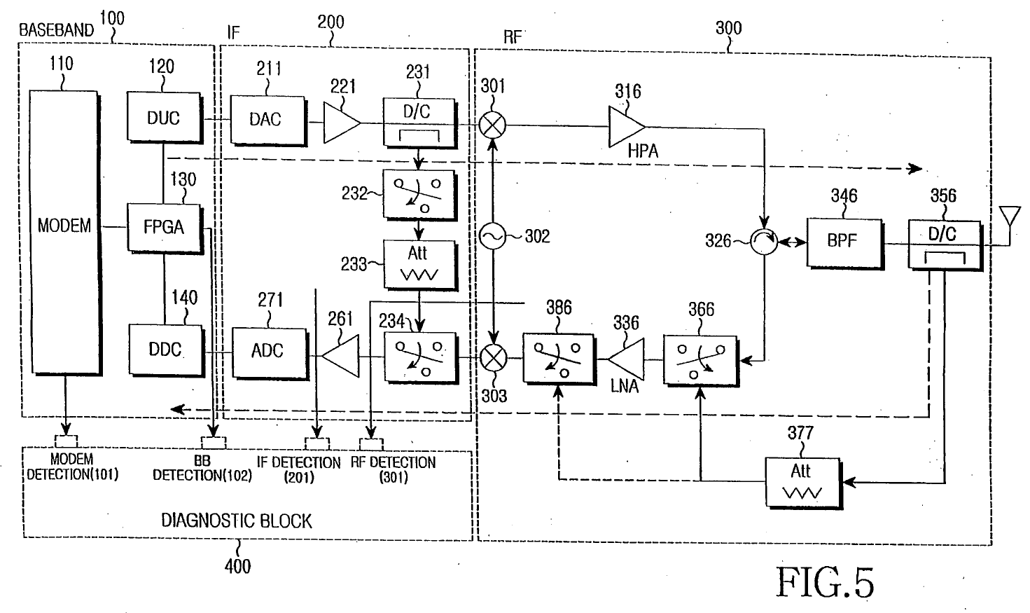

FIG. 5 illustrates diagnostic signal detection points in the TDD transceiver according to the present invention. Diagnostic signal detection refers to detection of a diagnostic signal traveling in a predetermined diagnostic path, e.g., paths L1 and L2, at predetermined points. The diagnostic block 400 presets diagnostic signal detection points and, when needed, collects diagnostic signals from the detection points, for diagnosis.

In accordance with the present invention, the power and quality of signals in Tx and Rx paths are diagnosed using Tx and Rx power from the baseband processor 100, the IF processor 200, and the RF processor 300. Further, bit error rate (BER) can be measured during processing the Tx and Rx signal to data. The diagnostic path may run to a higher layer as well as to the MODEM 110 of the baseband processor 100, so that even the higher layer can be covered in a diagnosis.

As described above, the diagnostic block 400 can diagnose the baseband processor 100 using a MODEM signal detected from the MODEM 110 and a baseband signal detected from the FPGA 130 in the baseband processor 100. Also, the diagnostic block 400 can diagnose the IF processor 200 using a signal detected from the front end of the ADC 271 and diagnose the RF processor 300 using an RF signal, which is not yet downconverted to an IF signal by the IF processor 200. Accordingly, the diagnostic block 400 detects abnormalities in the diagnostic path using the collected diagnostic signals.

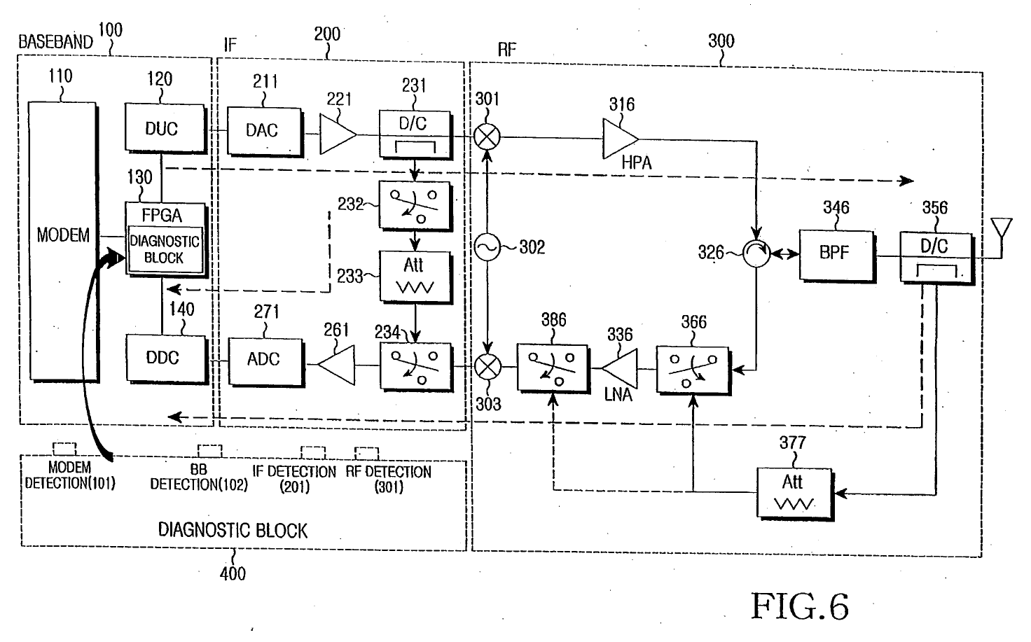

FIG. 6 illustrates a diagnostic block for detecting a diagnostic signal and diagnosing in the TDD transceiver according to the present invention. The diagnostic block 400 collects diagnostic signals at predetermined detection points through a MODEM port 101, a baseband detection port 102, an IF detection port 201, and an RF detection port 301 that detect the Tx and Rx power of the baseband processor 100, the IF processor 200, and the RF processor 300, respectively.

Although the diagnostic block 400 is typically configured externally, the present invention implements the diagnostic block 400 in the existing FPGA 130 of the baseband processor 100, thereby simplifying circuit configuration, as illustrated in FIG. 6. However, the diagnostic block 400 can also be implemented using a separate FPGA.

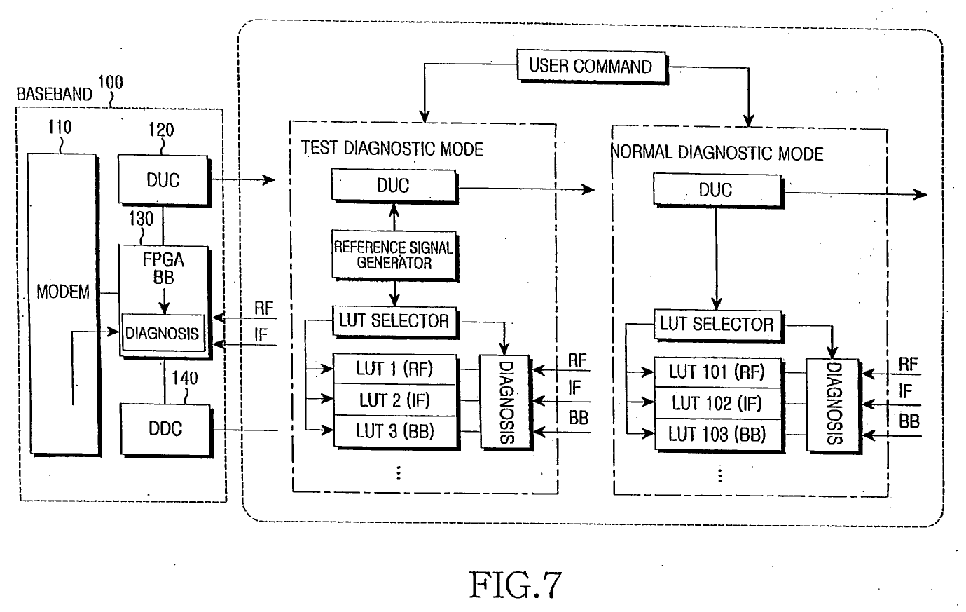

FIG. 7 is a block diagram illustrating the diagnostic block in the TDD transceiver according to the present invention. As described above, the diagnostic block is implemented within the FPGA 130 of the baseband processor 100. That is, the diagnostic block generates a predetermined test signal according to a user definition and request and operates in a test diagnostic mode, or in a normal diagnostic mode where TDD transmission and reception are carried out normally.

In the test diagnostic mode, the diagnostic block generates a reference signal of a predetermined shape at a predetermined power level through a reference signal generator, measures the strength of the reference signal detected from each path, and diagnoses the TDD transceiver based on the measurement. This mode is performed before a normal operation in order to determine whether the TDD transceiver is normal, when the system is initially installed or some device is replaced.

The normal diagnostic mode is set to monitor the operation status of the TDD transceiver in real time during a normal operation. Diagnostic signals detected in the transmitter of the TDD transceiver are used in the normal diagnostic mode. The diagnostic signals are subject to baseband signal processing and filtering in the FPGA 130, and information about the diagnostic signals, e.g., power and quality, is provided to the diagnostic block.

The diagnostic signals are Tx signals that have passed through the baseband, IF band, and the RF band. As described above, the diagnostic signals are detected from a plurality of detection points. The diagnostic block compares the values of the detected signals with values stored in internal look-up tables (LUTs) and determines whether the detected signals are normal or not.

The LUTs are databases having thresholds, which were empirically acquired as normal operation values based on Tx signal information. The thresholds are about the power and quality of signals, set by the user.

Referring to FIG. 7, first, second, and third LUTs (LUT 1, LUT 2 and LUT 3) have normal baseband, IF, and RF operation values in relation to the reference signal. Detected reference signals are compared with the baseband, IF, and RF thresholds, respectively, for diagnosis in the test diagnostic mode.

Diagnosis in the normal diagnostic mode is the same as that in the test diagnostic mode, except that the output of the transmitter, not the reference signal, is compared with a normal operation value.

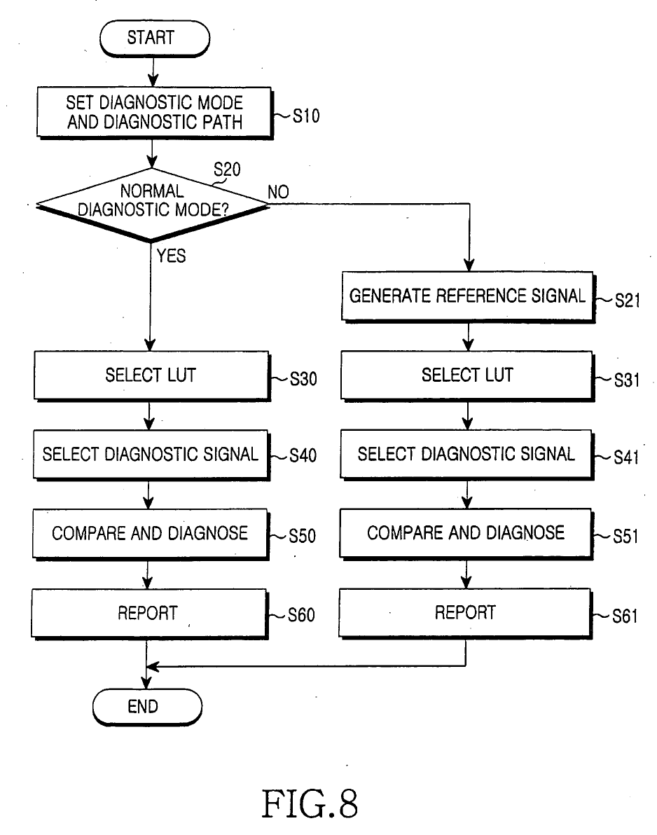

FIG. 8 is a flowchart illustrating a diagnosing procedure in a TDD transceiver according to the present invention. Referring to FIG. 8, the user sets the test diagnostic mode or the normal diagnostic mode and sets a diagnostic path in step S10. Basically, the diagnostic path is set such that a Tx signal is extracted from the front end of the RF processor and detected from the baseband processor. In another case, the user sets Tx signal extraction and detection points. The diagnostic block operates according to the set diagnostic mode.

In the normal diagnostic mode in step S20, the diagnostic block selects an LUT according to diagnostic mode information and a diagnostic signal detection point in step S30. A diagnostic signal is a Tx signal detected from the transmitter in the normal diagnostic mode. Accordingly, the diagnostic block collects diagnostic signals at the predetermined detection points in the predetermined diagnostic path. The diagnostic block then selects a diagnostic signal detected from a specific detection point to be compared with the LUT in step S40.

The diagnostic block compares a threshold set in the LUT with the selected diagnostic signal and determines whether the power and quality of the detected signal are normal or abnormal in the Tx and Rx paths in step S50. The diagnosis result is reported, upon user request in step S60.

In the test diagnostic mode in step S20, the diagnosing block generates a reference signal through the reference signal generator in step S21. In the same manner as in the normal diagnostic mode, the diagnosing block selects an LUT based on the diagnostic mode information and a detection point in step S31.

The reference signal is used as a diagnostic signal in the test diagnostic mode. The diagnosing block collects diagnostic signals at the predetermined detection points in the predetermined diagnostic path. The diagnosing block then selects a diagnostic signal from a specific detection point to be compared with the LUT in step S41.

The diagnostic block compares a threshold set in the LUT with the selected diagnostic signal and determines whether the power and quality of the detected signal are normal or abnormal in the Tx and Rx paths in step S51. As described above, the LUT has the threshold that is a normal operation value empirically preset using the reference signal. The diagnosis result is reported, preferably, upon user request, in step S61.

As described above, the present invention advantageously enables real-time monitoring of the performance characteristics of a TDD transceiver using an existing Rx path and circuit. Therefore, the TDD transceiver is efficiently diagnosed, and cost is reduced because an additional diagnostic block is not needed.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A time division duplex (TDD) transceiver in a wireless communication system, comprising:
a transmitter for transmitting a transmission (Tx) signal from a Tx path to an antenna;
a receiver for processing a received (Rx) signal to a baseband signal;
a detector for coupling the Tx signal in the transmitter and providing the coupled Tx signal to the receiver; and
a diagnostic portion for determining if the TDD transceiver is normal using the Tx signal received from the receiver.

2. The TDD transceiver of claim 1, wherein the Tx signal from the Tx path is one of an intermediate frequency (IF) signal and a radio frequency (RF) signal.

3. The TDD transceiver of claim 1, wherein the detector comprises:
a directional coupler for coupling the Tx signal;
an attenuator for attenuating the coupled signal to a signal with a power level at which an RX circuit can operate normally; and
a switch for switching the attenuated signal to the Rx circuit.

4. The TDD transceiver of claim 1, wherein the detector is provided between one of an IF processor and an RF processor.

5. The TDD transceiver of claim 1, wherein the diagnostic portion is included in a field programmable gate array (FPGA) of the baseband processor.

6. A time division duplex (TDD) transceiver in a wireless communication system, comprising:
an output portion for transmitting a transmission (Tx) radio frequency (RF) signal to an antenna;
a receiver for processing a received (Rx) signal to a baseband signal;
a detector for detecting the Tx signal in the output portion and providing the detected Tx signal to the receiver; and
a diagnostic portion for determining if the TDD transceiver is normal using the Tx signal received from the receiver.

7. The TDD transceiver of claim 6, wherein the detector comprises:
a directional coupler for coupling the Tx signal;
an attenuator for attenuating the coupled signal to a signal with a power level at which an RX circuit can operate normally; and
a switch for switching the attenuated signal to the Rx circuit.

8. The TDD transceiver of claim 6, wherein the diagnostic portion is included in a field programmable gate array (FPGA) of a baseband processor.

9. A time division duplex (TDD) transceiver in a wireless communication system, comprising:
an output portion for transmitting a transmission (Tx) radio frequency (RF) signal to an antenna;
a receiver for processing a received (Rx) signal to a baseband signal;
a detector for receiving a leakage signal from the output portion and providing the leakage signal to the receiver; and
a diagnostic portion for determining if the TDD transceiver is normal using the leakage signal received from the receiver.

10. The TDD transceiver of claim 9, wherein the detector comprises:
an attenuator for attenuating the leakage signal to a signal with a power level at which an RX circuit can operate normally;
a first switch for providing the leakage signal to an attenuator in a Tx mode; and
a second switch for switching the attenuated signal to the Rx circuit.

11. The TDD transceiver of claim 9, wherein the output portion comprises one of a circulator and a switch.

12. The TDD transceiver of claim 9, wherein the diagnostic portion is included in a field programmable gate array (FPGA) of the baseband processor.

13. A time division duplex (TDD) transceiver in a wireless communication system, comprising:
a transmitter for transmitting a transmission (Tx) signal from a Tx path to an antenna;
a receiver for processing a received (Rx) signal to a baseband signal;
a first detector for detecting an intermediate frequency (IF) signal from the transmitter and providing the detected IF signal to the receiver;
a second detector for detecting a radio frequency (RF) signal from the transmitter and providing the detected RF signal to the receiver; and
a diagnostic portion for determining if the TDD transceiver is normal using one of the IF and the RF signal received from the receiver.

14. The TDD transceiver of claim 13, wherein the first detector comprises:
a directional coupler for coupling the IF signal;
an attenuator for attenuating the coupled IF signal to a signal with a power level at which an RX circuit can operate normally; and
a switch for switching the attenuated IF signal to the Rx circuit.

15. The TDD transceiver of claim 14, wherein the switch switches one of the IF signal detected by the first detector and the RF signal detected by the second detector to the diagnostic portion.

16. The TDD transceiver of claim 13, wherein the second detector comprises:
a directional coupler for coupling the RF signal;
an attenuator for attenuating the coupled RF signal to a signal with a power level at which an RX circuit can operate normally; and
a switch for switching the attenuated RF signal to the Rx circuit.

17. The TDD transceiver of claim 13, wherein the second detector comprises:
an attenuator for attenuating a leakage signal to a signal with a power level at which the RX circuit can operate normally;
a first switch for switching the leakage signal to the attenuator in a Tx mode; and
a second switch for switching the attenuated leakage signal to the Rx circuit.

18. The TDD transceiver of claim 13, wherein the diagnostic portion is included in a field programmable gate array (FPGA) of a baseband processor.

19. A time division duplex (TDD) transceiving method in a wireless communication system, comprising the steps of:
transmitting a transmission (Tx) signal from a Tx path to an antenna;
coupling the Tx signal in the Tx path;
providing the coupled Tx signal to a reception (Rx) path; and
determining if transmission and reception are normal using the Tx signal received from the Rx path.

20. The TDD transceiving method of claim 19, wherein the Tx signal from the Tx path is one of a baseband signal, an intermediate frequency (IF) signal, and a radio frequency (RF) signal.

21. The TDD transceiving method of claim 19, further comprising the step of attenuating the coupled Tx signal to a signal with a power level at which an RX circuit can operate normally.

22. A self-diagnostic method for a time division duplex (TDD) transceiver in a wireless communication system, comprising the steps of:
setting a normal diagnostic mode;
setting a diagnostic path;
selecting one of a plurality of diagnostic threshold look-up tables (LUTs);
selecting a diagnostic signal detected from a user-set point; and
comparing the diagnostic signal with the diagnostic threshold LUT in order to determine if the TDD transceiver operates normally.

23. The self-diagnostic method of claim 22, wherein the plurality of diagnostic threshold LUTs have different values according to diagnostic signal detection points, each LUT having a threshold indicating a threshold power level and a threshold quality level to be compared to the power and quality of a diagnostic signal.

24. A self-diagnostic method for a time division duplex (TDD) transceiver in a wireless communication system, comprising the steps of:
setting a test diagnostic mode;
setting a diagnostic path;
generating a reference signal;
selecting one of a plurality of diagnostic threshold look-up tables (LUTs);
selecting a reference signal detected from a user-set point as a diagnostic signal; and
comparing the diagnostic signal with the diagnostic threshold LUT in order to determine if the TDD transceiver operates normally.

25. The self-diagnostic method of claim 24, wherein the plurality of diagnostic threshold LUTs have different values according to diagnostic signal detection points, each LUT having a threshold indicating a threshold power level and a threshold quality level to be compared to the power and quality of a diagnostic signal.
